(19) United States
(12) Patent Application Publication
(10) Pub. No.: US 2023/0018042 A1
(43) Pub. Date: Jan. 19, 2023

(54) ATTACK DETECTION SYSTEM, ATTACK DETECTION METHOD, AND COMPUTER-READABLE MEDIUM

(71) Applicant: MITSUBISHI ELECTRIC CORPORATION, Tokyo (JP)

(72) Inventor: Yoshihiro KOSEKI, Tokyo (JP)

(73) Assignee: MITSUBISHI ELECTRIC CORPORATION, Tokyo (JP)

(21) Appl. No.: 17/945,297

(22) Filed: Sep. 15, 2022

Related U.S. Application Data
(63) Continuation of application No. PCT/JP2020/019381, filed on May 15, 2020.

(51) Int. Cl. G06F 21/55

(52) U.S. Cl. CPC G06F 21/554; G06F 2221/034

(57) ABSTRACT

A selection unit (312) selects, from among a plurality of one-class classifiers (313) corresponding to mutually different classes, a one-class classifier corresponding to a class into which input data has been classified by multiclass classification on the input data. The selected one-class classifier executes one-class classification on the input data, thereby calculating a score. A determination unit (314) determines whether a result of multiclass classification on the input data is an erroneous result due to an adversarial example attack, on a basis of the calculated score.

### CROSS REFERENCE TO RELATED APPLICATIONS

This application is a Continuation of PCT International Application No. PCT/JP2020/019381, filed on May 15, 2020, which is hereby expressly incorporated by reference into the present application.

### TECHNICAL FIELD

The present disclosure relates to detection of an adversarial example attack against a multiclass classifier.

### BACKGROUND ART

A technique of constructing a multiclass classifier by supervised machine learning is known. The multiclass classifier classifies on a basis of labeled learning data a class to which input data belongs. In particular, a deep learning technique using a neural network has achieved high accuracy in various tasks.

Non-Patent Literature 1 describes an adversarial example attack against a multiclass classifier constructed by deep learning. The adversarial example attack applies perturbation to input data so that a classification result of a multiclass classifier is misled.

### CITATION LIST

### Non-Patent Literature

Non-Patent Literature 1: Christian Szegedy, Wojciech Zaremba, Ilya Sutskever, Joan Bruna, Dumitru Erhan, Ian J. Goodfellow and Rob Fergus: Intriguing properties of neural networks, in International Conference on Learning Representations (ICLR) (2014)

### SUMMARY OF INVENTION

### Technical Problem

An objective of the present disclosure is to enable detection of an adversarial example attack against a multiclass classifier.

### Solution to Problem

An attack detection system of the present disclosure includes:

a plurality of one-class classifiers corresponding to mutually different classes;

a selection unit to select, from among the plurality of one-class classifiers, a one-class classifier corresponding to a class into which input data has been classified by multiclass classification on the input data; and

a determination unit to determine whether a result of multiclass classification on the input data is an erroneous result due to an adversarial example attack, on a basis of a score calculated by one-class classification performed on the input data by the selected one-class classifier.

### Advantageous Effects of Invention

According to the present disclosure, it is possible to detect an adversarial example attack against a multiclass classifier.

### BRIEF DESCRIPTION OF DRAWINGS

FIG. 1 is a configuration diagram of an attack detection system 100 in Embodiment 1.

FIG. 2 is a configuration diagram of a classification device 200 in Embodiment 1.

FIG. 3 is a configuration diagram of a detection device 300 in Embodiment 1.

FIG. 4 is a flowchart of an attack detection method in Embodiment 1.

FIG. 5 is a flowchart of a classification process (S110) in Embodiment 1.

FIG. 6 is a schematic diagram of the classification device 200 in Embodiment 1.

FIG. 7 is a flowchart of a detection process (S120) in Embodiment 1.

FIG. 8 is a schematic diagram of the detection device 300 in Embodiment 1.

FIG. 9 is a hardware configuration diagram of the classification device 200 in Embodiment 1.

FIG. 10 is a hardware configuration diagram of the detection device 300 in Embodiment 1.

### DESCRIPTION OF EMBODIMENTS

In the embodiment and drawings, the same element or equivalent element is denoted by the same reference sign. A description of an element denoted by the same reference sign as that of a described element will be arbitrarily omitted or simplified. Arrows in the drawings mainly indicate data flows or processing flows.

### Embodiment 1

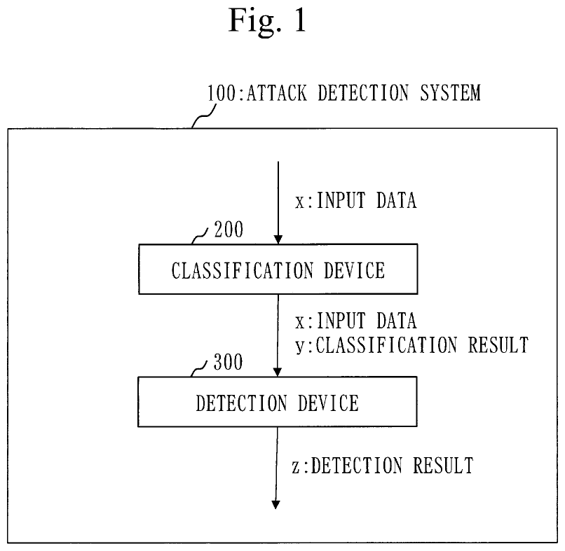

With referring to FIGS. 1 through 8, a description will be made on a mode in which it is possible to detect that an erroneous classification result is obtained by multiclass classification if input data of multiclass classification is altered by an adversarial example attack.

### Description of Configurations

A configuration of an attack detection system 100 will be described with referring to FIG. 1.

The attack detection system 100 is provided with a classification device 200 and a detection device 300.

The classification device 200 classifies input data x by multiclass classification. A classification result y indicates a class into which the input data x has been classified.

The detection device 300 determines by one-class classification whether the classification result y is an erroneous result due to an adversarial example attack. A detection result z indicates whether the classification result y is an erroneous result due to the adversarial example attack.

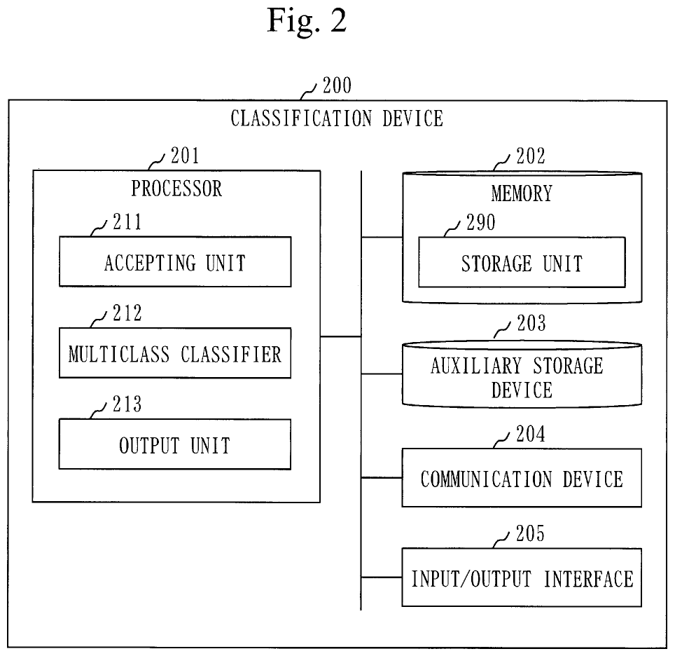

A configuration of the classification device 200 will be described with referring to FIG. 2.

The classification device 200 is a computer provided with hardware devices such as a processor 201, a memory 202, an auxiliary storage device 203, a communication device 204, and an input/output interface 205. These hardware devices are connected to each other via a signal line.

The processor 201 is an IC to perform arithmetic processing and controls the other hardware devices. For example, the processor 201 is a CPU.

IC stands for Integrated Circuit.

CPU stands for Central Processing Unit.

The memory 202 is a volatile or non-volatile storage device. The memory 202 is called a main storage device or a main memory as well. For example, the memory 202 is a RAM. Data stored in the memory 202 is saved in the auxiliary storage device 203 as necessary.

RAM stands for Random-Access Memory.

The auxiliary storage device 203 is a non-volatile storage device. For example, the auxiliary storage device 203 is a ROM, an HDD, or a flash memory. Data stored in the auxiliary storage device 203 is loaded to the memory 202 as necessary.

ROM stands for Read-Only Memory.

HDD stands for Hard Disk Drive.

The communication device 204 is a receiver/transmitter. For example, the communication device 204 is a communication chip or an NIC.

NIC stands for Network Interface Card.

The input/output interface 205 is a port to which an input device and an output device are connected. For example, the input/output interface 205 is a USB terminal, the input device is a keyboard-and-mouse, and the output device is a display. USB stands for Universal Serial Bus.

The classification device 200 is provided with elements such as an accepting unit 211, a multiclass classifier 212, and an output unit 213. These elements are implemented by software.

The multiclass classifier 212 is constructed by a neural network. For example, the multiclass classifier 212 is constructed with using VGG16 or ResNet50.

A classification program to cause the computer to function as the accepting unit 211, the multiclass classifier 212, and the output unit 213 is stored in the auxiliary storage device 203. The classification program is loaded to the memory 202 and run by the processor 201.

Further, an OS is stored in the auxiliary storage device 203. At least part of the OS is loaded to the memory 202 and run by the processor 201.

The processor 201 runs the classification program while running the OS.

OS stands for Operating System.

Input/output data of the classification program is stored in a storage unit 290. The memory 202 functions as the storage unit 290. Note that a storage device such as the auxiliary storage device 203, a register in the processor 201, and a cache memory in the processor 201 may function as the storage unit 290 in place of the memory 202 or together with the memory 202.

The classification device 200 may be provided with a plurality of processors that substitute for the processor 201.

The classification program can be computer-readably recorded (stored) in a non-volatile recording medium such as an optical disk and a flash memory.

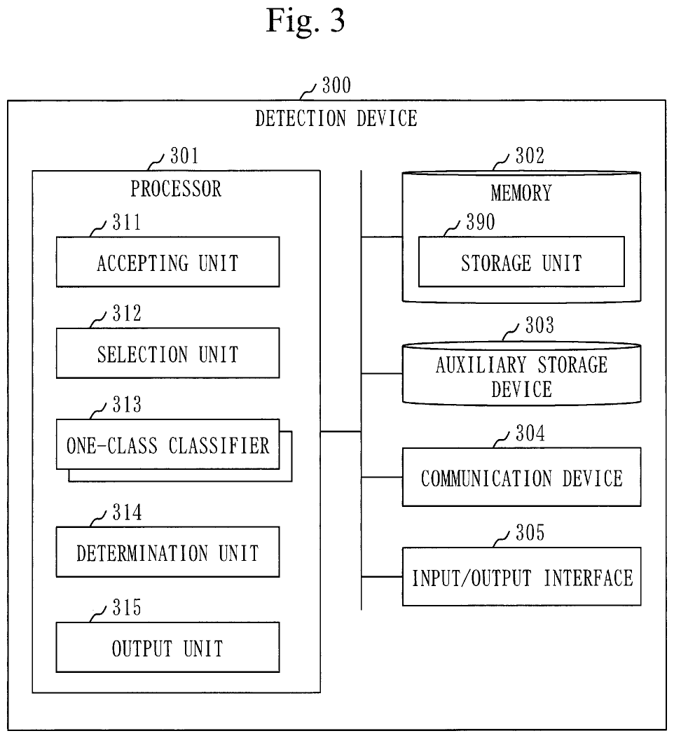

A configuration of the detection device 300 will be described with referring to FIG. 3.

The detection device 300 is a computer provided with hardware devices such as a processor 301, a memory 302, an auxiliary storage device 303, a communication device 304, and an input/output interface 305. These hardware devices are connected to each other via a signal line.

The processor 301 is an IC to perform arithmetic processing and controls the other hardware devices. For example, the processor 301 is a CPU.

The memory 302 is a volatile or non-volatile storage device. The memory 302 is called a main storage device or a main memory as well. For example, the memory 302 is a RAM. Data stored in the memory 302 is saved in the auxiliary storage device 303 as necessary.

The auxiliary storage device 303 is a non-volatile storage device. For example, the auxiliary storage device 303 is a ROM, an HDD, or a flash memory. Data stored in the auxiliary storage device 303 is loaded to the memory 302 as necessary.

The input/output interface 305 is a port to which an input device and an output device are connected. For example, the input/output interface 305 is a USB terminal, the input device is a keyboard-and-mouse, and the output device is a display.

The communication device 304 is a receiver/transmitter. For example, the communication device 304 is a communication chip or an NIC.

The detection device 300 is provided with elements such as an accepting unit 311, a selection unit 312, a determination unit 314, and an output unit 315. Further, the detection device 300 is provided with a plurality of one-class classifiers 313 corresponding to mutually different classes. These elements are implemented by software.

The plurality of one-class classifiers 313 execute one-class classification for mutually different classes.

A number of one-class classifiers 313 is the same as a number of classes that can be classified by the multiclass classifier 212. That is, the one-class classifiers 313 are constructed to correspond to individual classes that can be classified by the multiclass classifier 212.

The one-class classifiers 313 are constructed with using a set of unlabeled normal data as learning data. That is, the one-class classifiers 313 are constructed by unsupervised learning.

Each one-class classifier 313 executes one-class classification on input data and outputs a score.

The score expresses a degree at which the input data is included in a class corresponding to the individual one-class classifier 313. If the score is smaller than a threshold value, the input data is included in the set of normal data utilized as the learning data when constructing the one-class classifiers 313. If the score is larger than the threshold value, the input data is not included in the set of normal data utilized as the learning data when constructing the one-class classifiers 313.

For example, each one-class classifier 313 can utilize a scheme based on an autoencoder indicated in the following [Patent Literature] or a scheme based on Generative Adversarial Networks indicated in the following [Non-Patent Literature].
[Patent Literature] JP 2017-97718 A

[Non-Patent Literature] Thomas Schlegl, Philipp Seebock, Sebastian M. Waldstein, Ursula Schmidt-Erfurth and Georg Langs: Unsupervised Anomaly Detection with Generative Adversarial Networks to Guide Marker Discovery, in International Conference on Information Processing in Medical Imaging (IPMI) (2017)

A detection program to cause the computer to function as the accepting unit 311, the selection unit 312, the plurality of one-class classifiers 313, the determination unit 314, and the output unit 315 is stored in the auxiliary storage device 303. The detection program is loaded to the memory 302 and run by the processor 301.

Further, an OS is stored in the auxiliary storage device 303. At least part of the OS is loaded to the memory 302 and run by the processor 301.

The processor 301 runs the detection program while running the OS.

Input/output data of the detection program is stored in the storage unit 390.

The memory 302 functions as a storage unit 390. Note that a storage device such as the auxiliary storage device 303, a register in the processor 301, and a cache memory in the processor 301 may function as the storage unit 390 in place of the memory 302 or together with the memory 302.

The detection device 300 may be provided with a plurality of processors that substitute for the processor 301.

The detection program can be computer-readably recorded (stored) in a non-volatile recording medium such as an optical disk and a flash memory.

Description of Operations

A procedure of operations of the attack detection system 100 corresponds to an attack detection method. The procedure of the operations of the attack detection system 100 also corresponds to a procedure of processes performed by an attack detection program. The attack detection program includes the classification program for the classification device 200 and the detection program for the detection device 300.

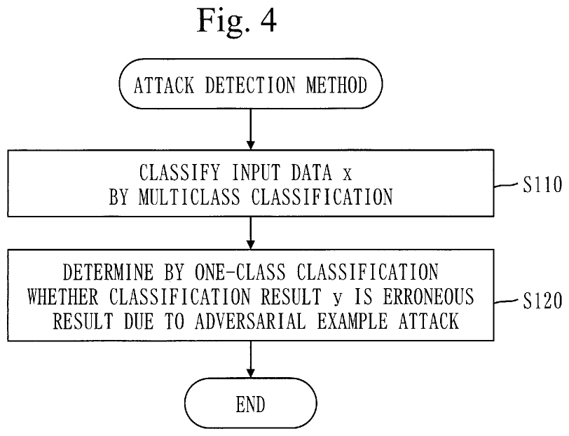

The attack detection method will be described with referring to FIG. 4.

In step S110, the classification device 200 classifies the input data x by multiclass classification.

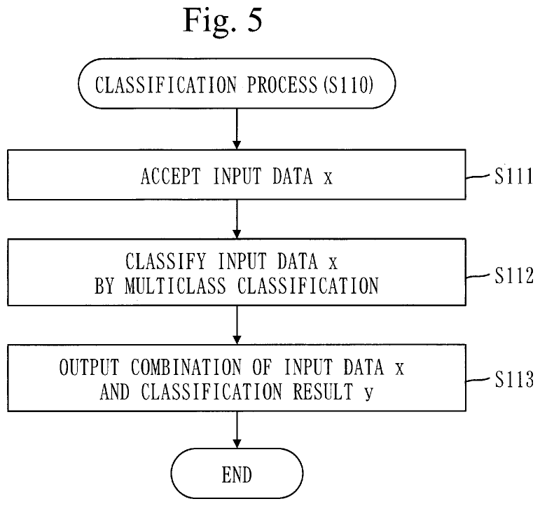

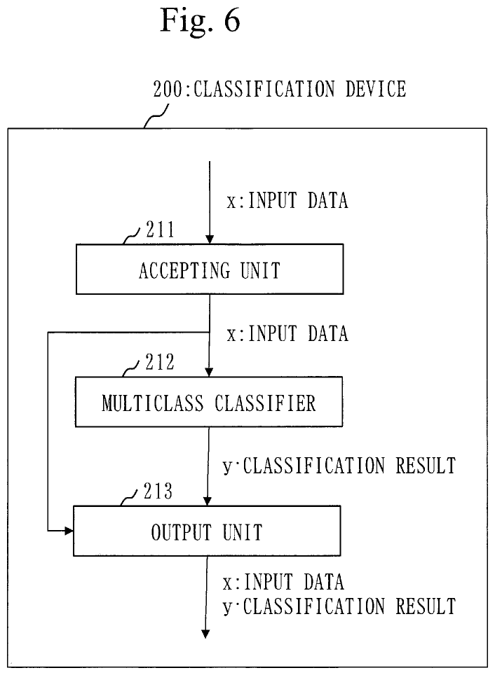

A procedure of a classification process (S110) by the classification device 200 will be described with referring to FIGS. 5 and 6.

FIG. 5 is a flowchart of the classification process (S110).

FIG. 6 illustrates input/output of individual elements of the classification device 200.

In step S111, the accepting unit 211 accepts the input data x.

The input data x is normal input data or illegal input data.

The normal input data has not been altered by an adversarial example attack.

The illegal input data has been altered by an adversarial example attack.

For example, a user inputs the input data x to the attack detection system 100. The accepting unit 211 accepts the input data x inputted to the attack detection system 100.

In step S112, the multiclass classifier 212 executes multiclass classification on the input data x. That is, the multiclass classifier 212 takes the input data x as input and executes multiclass classification. Then, the classification result y is outputted.

By multiclass classification, the input data x is classified into one of the plurality of classes.

The classification result y expresses a class into which the input data x has been classified.

In step S113, the output unit 213 outputs a combination of the input data x and the classification result y.

For example, the output unit 213 records the combination of the input data x and the classification result y on a recording medium. Alternatively, the output unit 213 transmits the combination of the input data x and the classification result y to the detection device 300.

Back to FIG. 4, step S120 will be described.

In step S120, the detection device 300 determines by one-class classification whether the classification result y is an erroneous result due to an adversarial example attack.

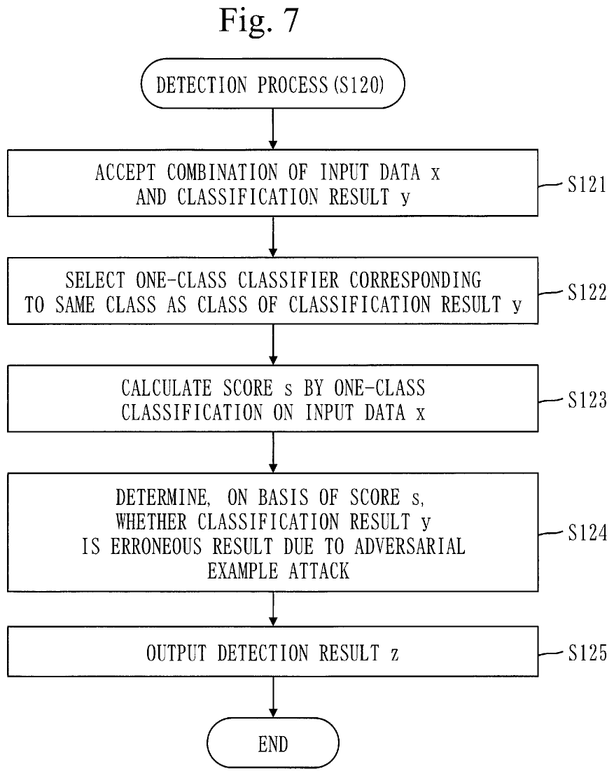

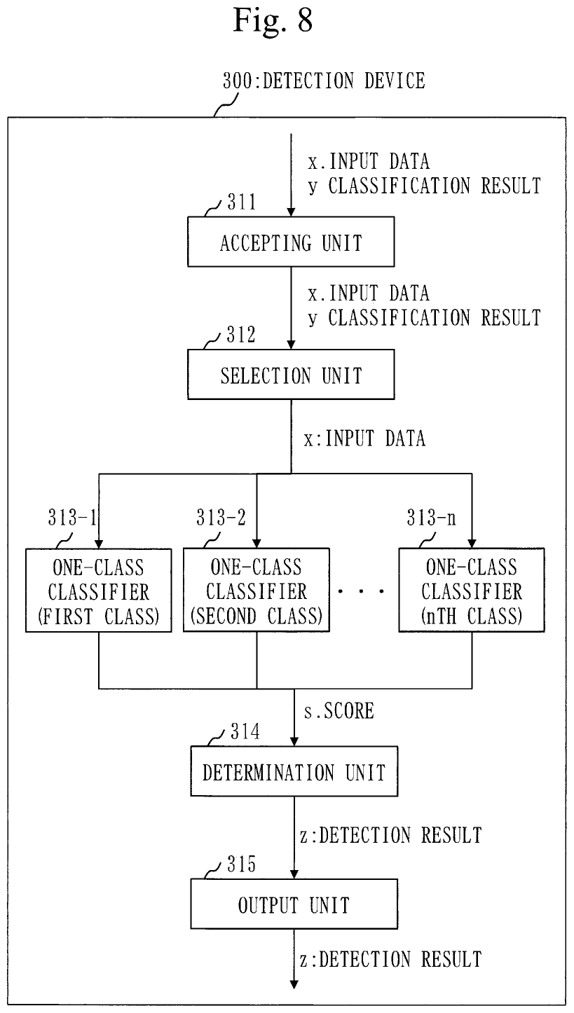

A procedure of a detection process (S120) by the detection device 300 will be described with referring to FIGS. 7 and 8.

FIG. 7 is a flowchart of the detection process (S120).

FIG. 8 illustrates input/output of individual elements of the detection device 300.

In step S121, the accepting unit 311 accepts the combination of the input data x and the classification result y.

For example, the user inputs the combination of the input data x and the classification result y to the detection device 300. The accepting unit 311 accepts the combination of the input data x and the classification result y inputted to the detection device 300.

For example, the classification device 200 transmits the combination of the input data x and the classification result y to the detection device 300. The accepting unit 311 receives the combination of the input data x and the classification result y.

In step S122, the selection unit 312 selects, from among the plurality of one-class classifiers 313, a one-class classifier 313 corresponding to the same class as the class indicated by the classification result y. Then, the selection unit 312 inputs the input data x to the selected one-class classifier 313.

For example, if the class indicated by the classification result y is a first class, the selection unit 312 selects a one-class classifier 313-1 (see FIG. 8) and inputs the input data x to the one-class classifier 313-1.

In step S123, the selected one-class classifier 313 executes one-class classification on the input data x. That is, the selected one-class classifier 313 takes the input data x as input and executes one-class classification. Hence, a score s is calculated.

In step S124, the determination unit 314 determines whether the classification result y is an erroneous result due to an adversarial example attack, on a basis of the score s.

The determination unit 314 performs determination as follows.

The determination unit 314 compares the score s with a threshold value. The threshold value is a predetermined value.

If the score s is smaller than the threshold value (or the score s is equal to or smaller than the threshold value), the result of multiclass classification and the result of one-class classification agree. Hence, the determination unit 314 determines that the classification result y is not an erroneous result due to the adversarial example attack.

If the score s is larger than the threshold value (or the score s is equal to or larger than the threshold value), the result of multiclass classification and the result of one-class classification do not agree. Hence, the determination unit 314 determines that the classification result y is an erroneous result due to the adversarial example attack.

In step S125, the output unit 315 outputs the detection result z corresponding to a result of determination in step S124.

The detection result z expresses “detected” or “not detected”.

Note that “detected” signifies that the classification result y is an erroneous result due to an adversarial example attack. That is, “detected” signifies that an adversarial example attack has been made.

Note that “not detected” signifies that the classification result y is not an erroneous result due to an adversarial example attack. That is, “not detected” signifies that an adversarial example attack has not been made.

For example, the output unit 315 records the detection result z on a recording medium. Alternatively, the output unit 315 displays the detection result z on a display.

### Effect of Embodiment 1

According to Embodiment 1, it is possible to detect that an erroneous classification result is obtained by multi-class specification if input data for multiclass classification is altered by an adversarial example attack. That is, it is possible to detect that the multiclass classifier 212 outputted an erroneous classification result y if the input data x altered by an adversarial example attack is supplied to the multiclass classifier 212.

### Supplementary to Embodiment

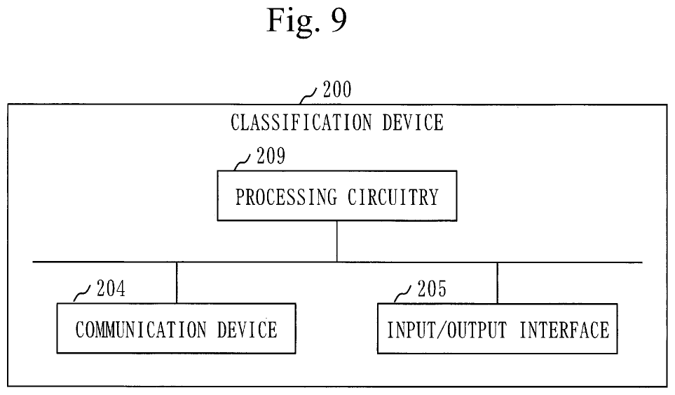

A hardware configuration of the classification device 200 will be described with referring to FIG. 9.

The classification device 200 is provided with processing circuitry 209.

The processing circuitry 209 is hardware that implements the accepting unit 211, the multiclass classifier 212, and the output unit 213.

The processing circuitry 209 may be dedicated hardware or may be a processor 201 that runs a program stored in the memory 202.

When the processing circuitry 209 is dedicated hardware, the processing circuitry 209 is, for example, a single circuit, a composite circuit, a programmed processor, a parallel-programmed processor, an ASIC, or an FPGA; or a combination of a single circuit, a composite circuit, a programmed processor, a parallel-programmed processor, an ASIC, and an FPGA.

ASIC stands for Application Specific Integrated Circuit.

FPGA stands for Field Programmable Gate Array.

The classification device 200 may be provided with a plurality of processing circuits that substitute for the processing circuitry 209.

In the processing circuitry 209, some of its function may be implemented by dedicated hardware, and the remaining functions may be implemented by software or firmware.

In this manner, the functions of the classification device 200 can be implemented by hardware, software, or firmware; or a combination of hardware, software, and firmware.

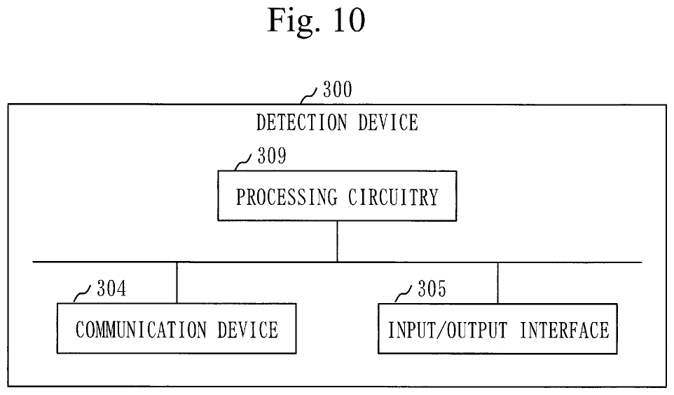

A hardware configuration of the detection device 300 will be described with referring to FIG. 10.

The detection device 300 is provided with processing circuitry 309.

The processing circuitry 309 is hardware that implements the accepting unit 311, the selection unit 312, the one-class classifiers 313, the determination unit 314, and the output unit 315.

The processing circuitry 309 may be dedicated hardware, or may be a processor 301 that runs a program stored in the memory 302.

When the processing circuitry 309 is dedicated hardware, the processing circuitry 309 is, for example, a single circuit, a composite circuit, a programmed processor, a parallel-programmed processor, an ASIC, or an FPGA; or a combination of a single circuit, a composite circuit, a programmed processor, a parallel-programmed processor, an ASIC, and an FPGA.

The detection device 300 may be provided with a plurality of circuits that substitute for the processing circuitry 309.

In the processing circuitry 309, some of its function may be implemented by dedicated hardware, and the remaining functions may be implemented by software or firmware.

In this manner, the functions of the detection device 300 can be implemented by hardware, software, or firmware; or a combination of hardware, software, and firmware.

Each embodiment is an exemplification of a preferred mode, and is not intended to limit a technical scope of the present disclosure. Each embodiment may be practiced partly, or may be practiced as a combination with another embodiment. The procedures described with using flowcharts and the like may be changed appropriately.

The classification device 200 and the detection device 300 may be implemented as one device. Also, each of the classification device 200 and the detection device 300 may be implemented by a plurality of devices.

A term “unit” referring to an individual element of each of the classification device 200 and the detection device 300 may be replaced by “process” or “stage”. Also, “classifier” may be replaced by “classification process” or “classification stage”.

### REFERENCE SIGNS LIST

100: attack detection system; 200: classification device; 201: processor; 202: memory; 203: auxiliary storage device; 204: communication device; 205: input/output interface; 209: processing circuitry; 211: accepting unit; 212: multiclass classifier; 213: output unit; 290: storage unit; 300: detection device; 301: processor; 302: memory; 303: auxiliary storage device; 304: communication device; 305: input/output interface; 309: processing circuitry; 311: accepting unit; 312: selection unit; 313: one-class classifier; 314: determination unit; 315: output unit; 390: storage unit.

1. An attack detection system comprising
processing circuitry including a plurality of one-class classifiers corresponding to mutually different classes,
to select, from among the plurality of one-class classifiers, a one-class classifier corresponding to a class into which input data has been classified by multiclass classification on the input data, and
to determine whether a result of multiclass classification on the input data is an erroneous result due to an adversarial example attack, on a basis of a score calculated by one-class classification performed on the input data by the selected one-class classifier.

2. The attack detection system according to claim 1,
wherein the processing circuitry, if the score is larger than a threshold value, determines that the result of multiclass classification on the input data is an erroneous result due to an adversarial example attack.

3. The attack detection system according to claim 1, comprising
a multiclass classifier to execute multiclass classification on the input data, thereby classifying the input data.

4. The attack detection system according to claim 1, comprising
wherein the processing circuitry outputs a detection result indicating whether the result of multiclass classification on the input data is an erroneous result due to an adversarial example attack.

5. The attack detection system according to claim 2, comprising
wherein the processing circuitry outputs a detection result indicating whether the result of multiclass classification on the input data is an erroneous result due to an adversarial example attack.

6. The attack detection system according to claim 3, comprising
wherein the processing circuitry outputs a detection result indicating whether the result of multiclass classification on the input data is an erroneous result due to an adversarial example attack.

7. The attack detection system according to claim 2, comprising
a multiclass classifier to execute multiclass classification on the input data, thereby classifying the input data.

8. The attack detection system according to claim 7, comprising
wherein the processing circuitry outputs a detection result indicating whether the result of multiclass classification on the input data is an erroneous result due to an adversarial example attack.

9. An attack detection method comprising:
selecting, from among a plurality of one-class classifiers corresponding to mutually different classes, a one-class classifier corresponding to a class into which input data has been classified by multiclass classification on the input data;
executing, with the selected one-class classifier, one-class classification on the input data, thereby calculating a score; and
determining whether a result of multiclass classification on the input data is an erroneous result due to an adversarial example attack, on a basis of the calculated score.

10. A non-transitory computer-readable medium recorded with an attack detection program which causes a computer to execute:
a selection process of selecting, from among a plurality of one-class classifiers corresponding to mutually different classes, a one-class classifier corresponding to a class into which input data has been classified by multiclass classification on the input data;
a one-class classification process of executing one-class classification on the input data by the selected one-class classifier, thereby calculating a score; and
a determination process of determining whether a result of the multiclass classification on the input data is an erroneous result due to an adversarial example attack, on a basis of the calculated score.
